(19) United States
(12) Patent Application Publication
(10) Pub. No.: US 2026/0147223 A1
(43) Pub. Date: May 28, 2026

(54) MODULARIZATION AND CALIBRATION OF AUGMENTED REALITY DISPLAY SYSTEMS

(71) Applicant: GOOGLE LLC, Mountain View, CA (US)

(72) Inventors: Qiyue John Zhang, Cupertino, CA (US); Zhiheng Jia, Sunnyvale, CA (US); Joshua Hernandez, Redwood City, CA (US)

(21) Appl. No.: 19/400,686

(22) Filed: Nov. 25, 2025

Related U.S. Application Data
(60) Provisional application No. 63/725,283, filed on Nov. 26, 2024.

(51) Int. Cl. G02B 27/62; G02B 27/01; G06F 30/27; G06F 111/20; G06F 119/14

(52) U.S. Cl. CPC G02B 27/62; G02B 27/0172; G06F 30/27; G02B 2027/0138; G02B 2027/0178; G06F 2111/20; G06F 2119/14

(57) ABSTRACT

Methods and systems are described for calibrating modular components of display system prior to assembly. Sensor data is collected from multiple modular components such as cameras, displays, and inertial measurement units under controlled testing conditions. Deformation parameters of a support frame are estimated based on the collected sensor data and preconfigured deformation models. Intrinsic parameters of each modular component, such as optical and alignment characteristics, are calibrated using the collected data. Extrinsic parameters, defining spatial relationships between the modular components, are calibrated based on the estimated deformation parameters. The calibrated intrinsic and extrinsic parameters are provided as output for use during assembly.

### BACKGROUND

The present disclosure relates generally to augmented reality (AR) and virtual reality (VR) devices, and more particularly to systems and methods for calibrating components of such devices for precise operation in various contexts.

AR and VR devices typically incorporate sophisticated components such as cameras, inertial measurement units (IMUs), displays, microphones, and speakers to provide immersive and interactive user experiences. These components work in concert to enable features like spatial tracking, gesture recognition, and audio-visual feedback. One important aspect of such functionality involves aligning the performance of these components in relation to one another and to the external environment, often referred to as the calibration process.

Calibration typically involves determining both the intrinsic parameters of each individual component—such as sensor biases, scale factors, and distortion characteristics —and the extrinsic parameters that define their spatial relationships to other components and to a global reference frame. Accurate calibration enables reliable tracking, stable rendering, and user comfort in AR/VR systems. In contrast, even slight misalignments in binocular displays can lead to visual discomfort, while errors in the alignment of IMUs and cameras can degrade motion tracking accuracy.

There remains a need for systems and methods that address these challenges by enabling efficient, scalable, and cost-effective calibration processes while maintaining or improving the accuracy of intrinsic and extrinsic parameter estimation for AR/VR devices.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 illustrates an example configuration of modular components integrated into an AR display system, in accordance with some embodiments.

FIG. 2 illustrates an example calibration configuration for modular components used in an exemplary AR display system, in accordance with some embodiments.

FIG. 3 illustrates spatial relationships between an inertial measurement unit and a camera within a module of an AR display system, in accordance with some embodiments.

FIG. 4 illustrates an example calibration configuration for calibrating camera modules in an AR display system, in accordance with some embodiments.

FIG. 5 illustrates a calibration process for a camera module using a calibu calibration target, in accordance with some embodiments.

FIG. 6 illustrates an example configuration for calibrating display modules in an AR display system, in accordance with some embodiments.

FIG. 7 illustrates an example configuration for calibrating audio modules in an AR display system, in accordance with some embodiments.

FIG. 8 illustrates a flowchart for modeling, estimating, and evaluating frame deformation in an AR display system, in accordance with some embodiments.

FIG. 9 illustrates a high-level workflow for developing, verifying, and validating algorithms for frame deformation calibration in an AR display system, in accordance with some embodiments.

FIG. 10 illustrates an example process for validating deformation calibration algorithms using a deformation rig and inertial measurement units, in accordance with some embodiments.

FIG. 11 illustrates a comparison of two workflows for achieving 6 degree of freedom (DoF) tracking and eye tracking in an AR display system, in accordance with some embodiments.

FIG. 12 illustrates a gyro noise model and simulation, in accordance with some embodiments.

FIG. 13 illustrates a simulation-based workflow for validating multi-IMU and camera systems in the context of deformation estimation, tracking accuracy, and display performance in AR display systems, in accordance with some embodiments.

FIG. 14 illustrates one embodiment of techniques for evaluating an alignment accuracy of an AR display system, in accordance with some embodiments.

FIG. 15 is a block diagram of a processing system designed to implement modular calibration of components in AR systems and other devices, in accordance with one or more embodiments.

### DETAILED DESCRIPTION

Existing calibration techniques are generally performed at the device level after assembly, requiring specialized calibration setups tailored to each device type. Such approaches often involve time-consuming, single-device calibration procedures and demand highly precise equipment. Moreover, any defects identified during the calibration process typically result in significant waste, as entire devices must be discarded or reworked. These factors contribute to high production costs and reduced yield rates, particularly for consumer-grade AR/VR devices designed for mass production.

Additional challenges arise due to the dynamic operating conditions of these devices. Factors such as mechanical stress, temperature changes, and aging can alter the alignment of components over time, further degrading calibration accuracy. Traditional calibration methods provide little or no capability to address such post-assembly changes, compounding the issues of cost, reliability, and user satisfaction.

Embodiments of techniques described herein provide systems and methods for modular calibration of components in augmented reality (AR) and virtual reality (VR) eyewear display devices, such as AR-or VR-enabled glasses and goggles. These embodiments facilitate the factory-level calibration of intrinsic parameters of individual modules, such as cameras, IMUs, displays, and audio devices, as well as extrinsic parameters defining the spatial relationships between components within each module. By calibrating modules prior to final assembly, these techniques reduce production costs, improve manufacturing yield, and enable efficient defect detection early in the process.

Additionally, embodiments enable online calibration of extrinsic parameters between modules post-assembly, addressing challenges such as mechanical deformation, temperature-induced misalignment, and aging effects that occur during device operation. These online calibration techniques use sensor data, such as centripetal accelerations and rotation vectors from multi-IMU systems, to dynamically estimate and correct changes in alignment, enabling consistent device performance and user comfort over time.

These systems and methods are applicable to a wide range of AR/VR devices, providing scalable and cost-effective solutions for producing high-performance products capable of adapting to dynamic operational conditions.

While examples herein discuss an AR display system, it will be appreciated that in various embodiments the described techniques may be applicable to a wide variety of other items having multiple components requiring intrinsic and/or extrinsic calibration.

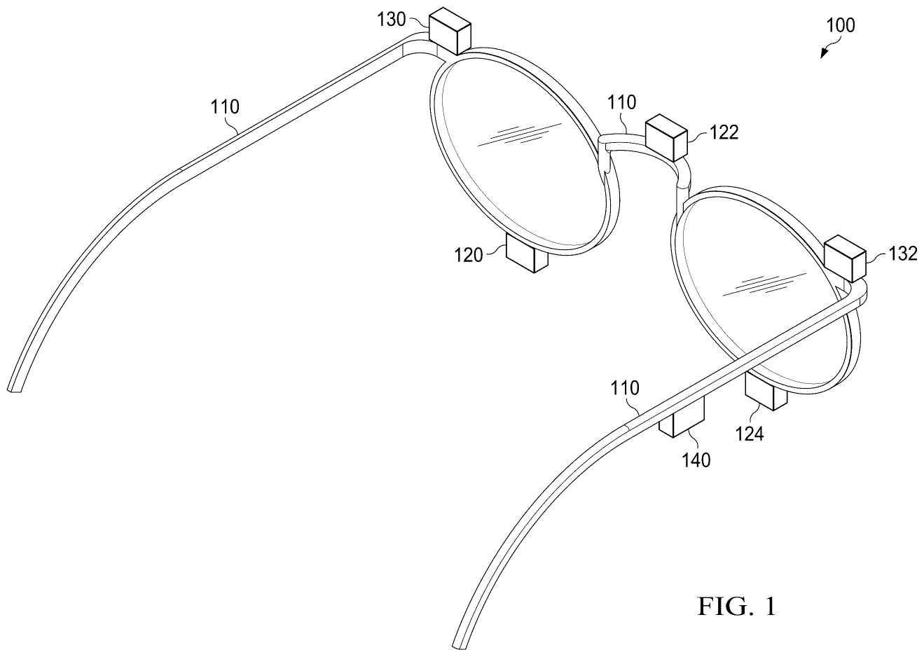

FIG. 1 illustrates an example configuration of modular components integrated into an AR display system 100, highlighting its modular design and arrangement in accordance with some embodiments. The depicted example shows a general layout of the AR display system 100, in which individual modules—each designed to perform specific functions—are distributed across a support frame 110 of the AR display system.

In the depicted embodiment, multiple camera modules 120, 122, 124 are positioned strategically along the support frame 110 to enable comprehensive spatial tracking and data capture. These camera modules 120, 122, 124 integrate both cameras and inertial measurement units (IMUs), allowing for accurate determination of intrinsic parameters (e.g., lens distortion and sensor biases) and extrinsic parameters (e.g., the spatial relationships between the camera modules, display modules, and other modules). The placement of these camera modules 120, 122, 124 ensures a wide field of view (FOV) and robust 6 degrees of freedom (6DoF) tracking.

The AR display system includes multiple display modules 130, 132 located near the temples of the support frame 110, positioned to align with the user's field of vision. Each display module 130, 132 integrates a display and an IMU, supporting both intrinsic calibration, such as pixel mapping, and extrinsic calibration, such as alignment with other components like cameras and audio devices.

An audio module 140 is situated near the temple arms of the AR display system, integrating speakers and IMUs for audio output and spatial audio calibration. The intrinsic parameters of the audio module 140 include signal-to-sound mapping, while extrinsic parameters define its spatial relationship with nearby modules, ensuring sound localization accuracy.

The modular architecture of AR display system 100 supports a production process in which the individual modules (e.g., modules 120, 130, 140) are factory-calibrated for their respective intrinsic and extrinsic parameters before assembly into the final AR display system 100. This modular approach enhances manufacturing efficiency by enabling batch calibration and early defect detection. After assembly, the system can perform online calibration to account for dynamic factors such as frame deformation due to temperature changes, aging, or operational stresses.

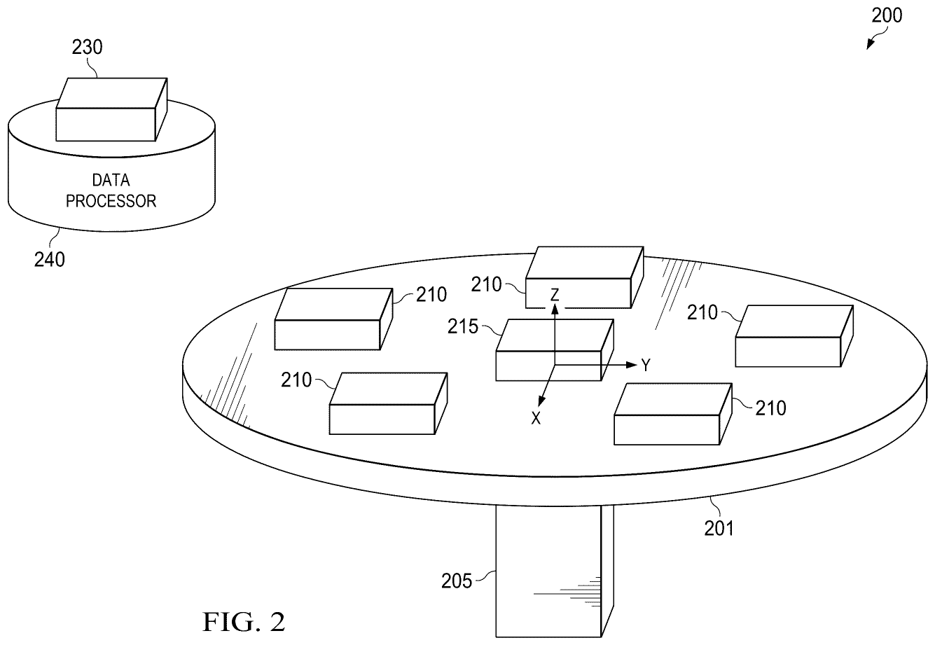

FIG. 2 illustrates an example calibration configuration for modular components used in an exemplary AR display system (e.g., AR display system 100 of FIG. 1). The calibration configuration may facilitate, for example, the production-level calibration of intrinsic and extrinsic parameters for individual modules before they are assembled into the final device.

The depicted calibration configuration 200 includes a test fixture 201 capable of rotating modules around multiple axes (x, y, and z) using a mechanism 205 such as gimbals or a robot arm. Multiple modules 210 are securely mounted on the test fixture 200, allowing batch calibration of several modules 210 simultaneously.

Each module 210 mounted on the calibration fixture 201 is communicatively coupled to a data processor 240 that is configured to collect sensor data 230 from the modules 210 during the calibration process. This sensor data 230 may include, as non-limiting examples, information from integrated sensors such as IMUs, cameras, or displays, depending on the module type. The data processor 240 then applies calibration algorithms to estimate intrinsic parameters (e.g., sensor biases, scale factors, and distortions) and extrinsic parameters (e.g., spatial relationships between components within a module).

By rotating the calibration fixture 201, the calibration system exposes each module 210 to various orientations relative to external reference points, such as gravity or a calibration target. For example, IMU calibration uses gravity as a reference for accelerometer parameters and controlled rotations for gyroscope parameters; camera modules may observe calibration targets with predefined patterns to determine lens distortion and alignment properties; and display modules can be calibrated by analyzing how specific pixel patterns appear in a controlled visual environment.

The depicted exemplary calibration process reduces production costs by identifying defective modules early in the manufacturing process, preventing their inclusion in final assemblies. Additionally, the depicted configuration enables scalable and repeatable calibration, enabling each module to satisfy one or more specified performance standards.

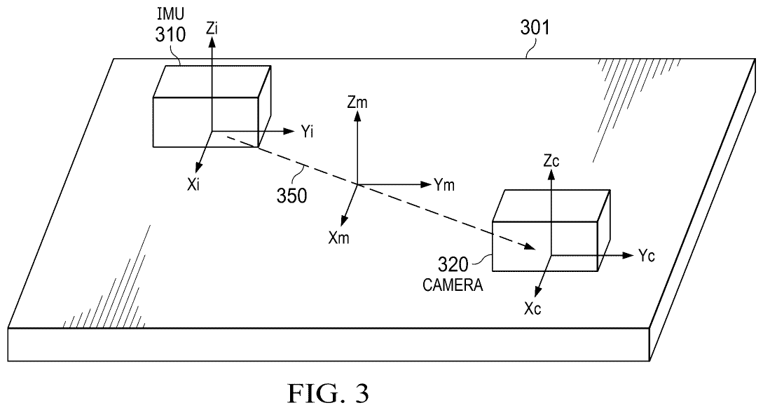

FIG. 3 illustrates the spatial relationship between an IMU and a camera within a module of an AR display system (e.g., display system 100 of FIG. 1). The diagram depicts the reference frames associated with each component and the transformations that define their spatial alignment.

The module frame 301 is defined by the axes Xₘ, Yₘ, and Zₘ, which serve as the global reference frame. Both an IMU module 310 and a camera module 320 are aligned and calibrated relative to this shared module frame.

The reference frame for IMU module 310 is represented by axes X_{i,} Yᵢ, and Zᵢ. The intrinsic parameters of the IMU module 310 include biases and scale factors associated with its accelerometer and gyroscope sensors. The spatial relationship of the IMU module 310 to the module frame is characterized by an extrinsic parameter, specifically a rotation matrix R_{m,i}, which defines the orientation of the IMU module 310 relative to the module frame 301.

The reference frame for camera module 320 is represented by axes X_{c}, Y_{c}, and Z_{c}. The intrinsic parameters of the camera module 320 include properties such as focal length, lens distortion coefficients, and the optical center. The spatial relationship of the camera module 320 to the module frame 301 is similarly defined by an extrinsic rotation matrix R_{m,c}.

Additionally, the extrinsic alignment between the IMU module 310 and the camera module 320 is represented by a translation vector 350 and a composite rotation matrix R_{c,i}. The translation vector 350 specifies the positional offset between the IMU module 310 and the camera module 320. The composite rotation matrix R_{c,i} captures the relative orientation of the IMU module 310 with respect to the camera module 320.

During the factory calibration process, these extrinsic parameters are estimated to ensure accurate alignment between the IMU module 310 and the camera module 320. This enables the calibration process to provide precise spatial data for the AR display system. For example, motion data from the IMU module 310 can be integrated with visual data from the camera module 320 for use in operations such as 6DoF tracking and gesture recognition.

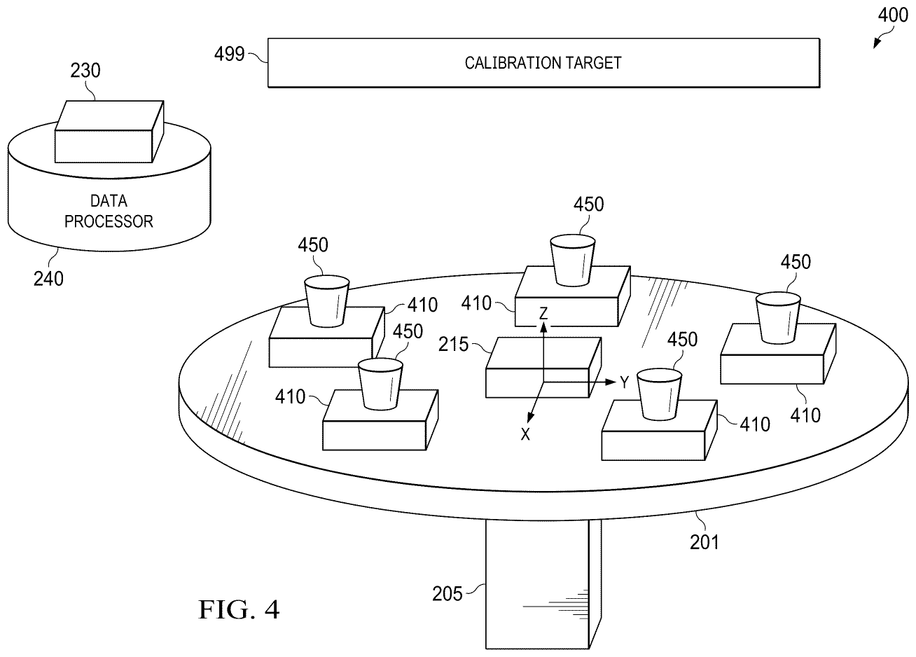

FIG. 4 illustrates an example calibration configuration 400 for calibrating camera modules 410 in an AR display system (e.g., AR display system 100 of FIG. 1), showing the arrangement of multiple camera modules 410, cameras 450, a calibration target 499, and calibration flange 215. This example calibration configuration 400 enables batch calibration of intrinsic and extrinsic parameters for camera modules 210 under controlled conditions, ensuring accurate alignment and performance.

In the depicted embodiment, multiple camera modules 410 are securely attached to a calibration fixture 201 that is capable of rotating along multiple axes using mechanisms 205 such as gimbals or a robot arm. Each camera module 410 includes a camera 450 positioned to observe a calibration target located above the fixture. In certain embodiments, the calibration target 499 contains a precisely defined pattern or structure (e.g., geometric shapes, grid points) that facilitates feature identification for calibration purposes.

A calibration flange 215, mounted on the same calibration fixture 201, serves as a shared calibration reference structure. It provides a stable and well-defined frame of reference for determining spatial relationships between components within each module 410 (e.g., cameras and IMUs) and between the modules 410.

The calibration target 499 is used to calibrate the intrinsic parameters of the cameras 450, such as lens distortion coefficients, focal length, and optical center. As the calibration fixture 201 rotates, the cameras 450 capture images of the calibration target 499 from multiple orientations, allowing the calibration process to optimize intrinsic parameters by minimizing projection errors based on the known geometry of the calibration target 499.

The data processor 240 collects image data from the cameras 450 and uses it to compute both intrinsic and extrinsic parameters. For intrinsic calibration, the data processor 240 estimates properties unique to each camera 450, such as optical distortion and alignment. For extrinsic calibration, the data processor 240 determines the spatial relationships between the flange 215, the cameras 450, and other components of modules 410, such as IMUs.

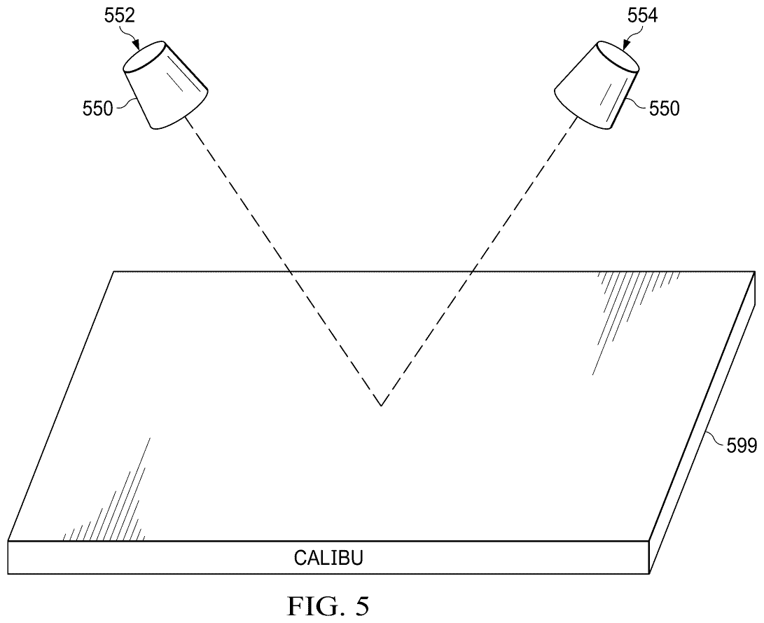

FIG. 5 illustrates a calibration process for a camera module using a calibration target referred to as calibu 599. The figure shows a camera 550 observing the calibu 599 from two distinct poses 552 and 554 (labeled Pose 1 and Pose 2) to facilitate the estimation of intrinsic and extrinsic parameters of the camera 550.

In the depicted example, the calibu 599 features a precisely defined pattern or markers, such as grids, dots, or geometric shapes, with known spatial coordinates. This target allows the calibration system to analyze how its features are projected onto the image plane of the camera 550, providing a reliable reference for calibration. The intrinsic parameters of the camera 550, including distortion coefficients, focal length, and optical center, may be derived by examining the relationships between the known features of the calibu 599 and their corresponding locations in the captured images.

Observing the calibu 599 from multiple poses, such as Pose 552 and Pose 554, enables the calibration process to estimate extrinsic parameters that define the alignment of the camera 550 within its incorporating module's reference frame. These extrinsic parameters describe the spatial relationship between the camera 550 and other components in the incorporating module.

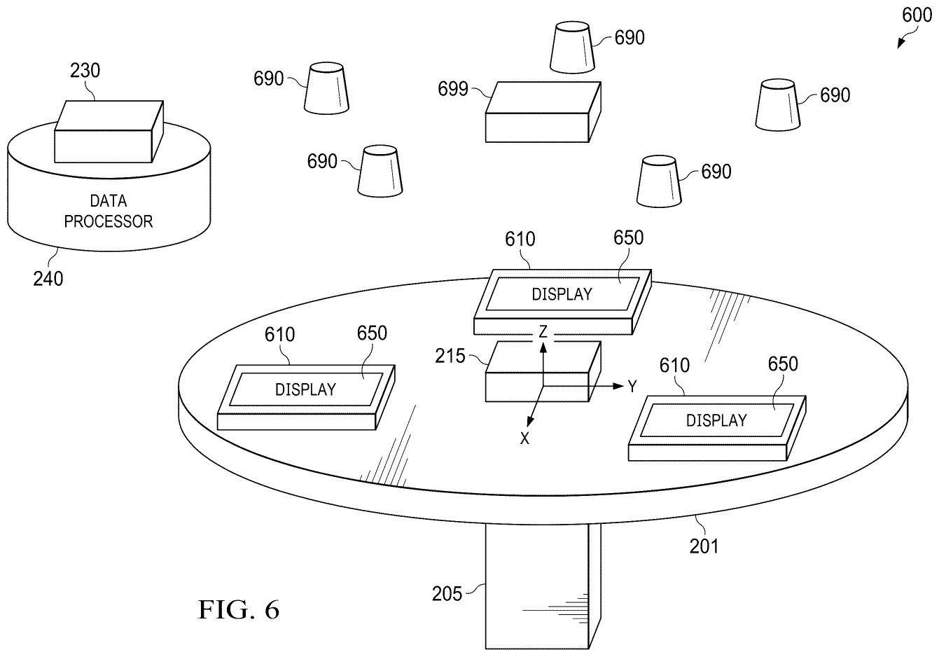

FIG. 6 illustrates an example configuration 600 for calibrating display modules in an AR display system(e.g., AR display system 100 of FIG. 1), showing the arrangement of the display modules 610, calibrated cameras 690, a calibration flange 215, and a data processor 240. This configuration enables accurate calibration of intrinsic and extrinsic parameters associated with the displays 650 of the display modules 610, in a manner similar to that described above with respect to the calibration configurations of FIGS. 2 and 4.

In the depicted embodiment, multiple display modules 610 are mounted on a rotatable fixture 201, which also supports a calibration flange 215. The calibration flange 215 provides a stable reference structure on the rotatable fixture 201, ensuring consistent alignment and calibration across the multiple display modules 610. The calibration fixture 201 can rotate along multiple axes (x, y, and z) using mechanism 205, allowing the modules 610 to be viewed from various perspectives by the calibration cameras 690, which are arranged around a central calibration hub 699.

Multiple calibration cameras 690 are positioned above the display modules 610, and are used to observe specific patterns displayed on each module 610 via its respective display 650. These calibration cameras 690 serve as reliable references for analyzing the patterns as displayed by the displays 650. By capturing how the patterns appear on those display modules from different angles, the calibration cameras 690 enable the calibration system to estimate the intrinsic parameters of the displays 650, such as pixel alignment, distortion characteristics, and perceived pixel locations.

The data processor 240 collects data from the calibrated cameras 690 and uses it to compute both the intrinsic parameters of the displays 650 and the extrinsic parameters defining their alignment within the respective module 610. The intrinsic calibration involves correlating the patterns output by displays 650 with their known pixel coordinates, while the extrinsic calibration ensures accurate spatial relationships between the displays 650 and other components within the corresponding module 610.

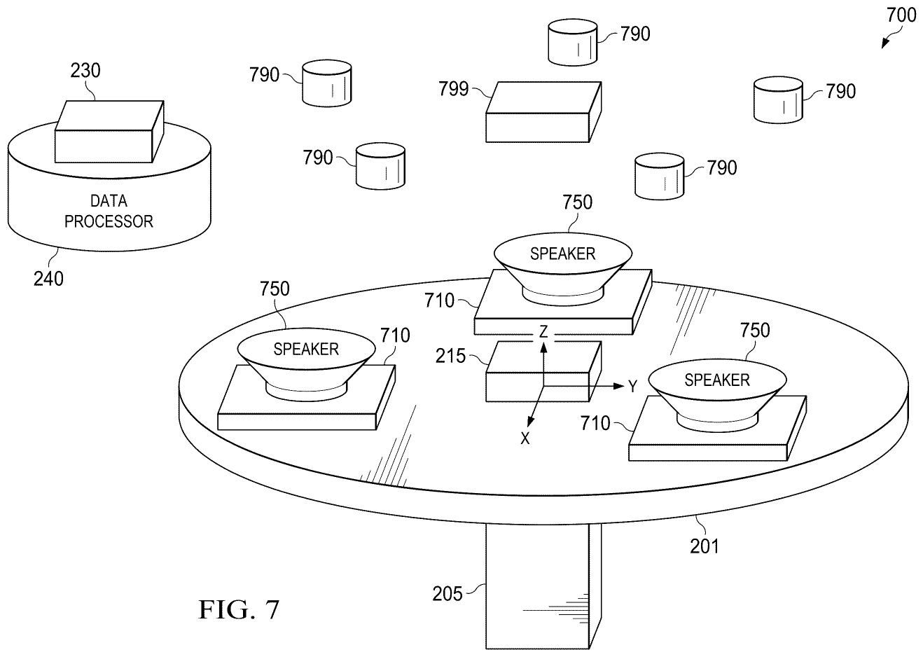

FIG. 7 illustrates an example configuration 700 for calibrating audio modules 710 in an AR display system (e.g., AR display system 100 of FIG. 1), showing the arrangement of audio modules 710, calibration microphones 790, a calibration flange 215, and a data processor 240. This configuration 700 is designed to accurately calibrate the intrinsic and extrinsic parameters of the audio modules 710, enabling precise sound reproduction and spatial audio performance.

In the depicted configuration, multiple calibration microphones 790 are positioned above and around the audio modules 710 to capture audio signals (not shown) emitted by the speakers 750 integrated into each module 710. These calibration microphones 790 are pre-calibrated and provide a reliable reference for analyzing the sound characteristics of speakers 750, such as intensity, frequency response, and directional properties. By recording how the sound propagates from the modules 710 under controlled conditions, the microphones 790 (arranged around a central calibration hub 799) enable the system to estimate the intrinsic parameters of the audio modules 710, such as signal-to-sound mapping and speaker distortion.

The data processor 240 collects audio data from the calibration microphones 790 and uses it to compute both intrinsic and extrinsic parameters of the audio modules 710 and their respective speakers 750. For intrinsic calibration, the data processor 240 evaluates the relationship between the electrical signals sent to the speakers 750 and the resulting sound output at various points in space as evaluated by calibration microphones 790. For extrinsic calibration, the data processor 240 determines the spatial relationships between the speakers 750, the calibration microphones 790, and the module 710, ensuring accurate sound localization and synchronization with other components.

The depicted example configuration supports the simultaneous calibration of multiple audio modules 710, improving efficiency and reducing production costs. By rotating the fixture and using multiple calibration microphones 790, the configuration 700 enables comprehensive characterization of the audio performance across different spatial configurations.

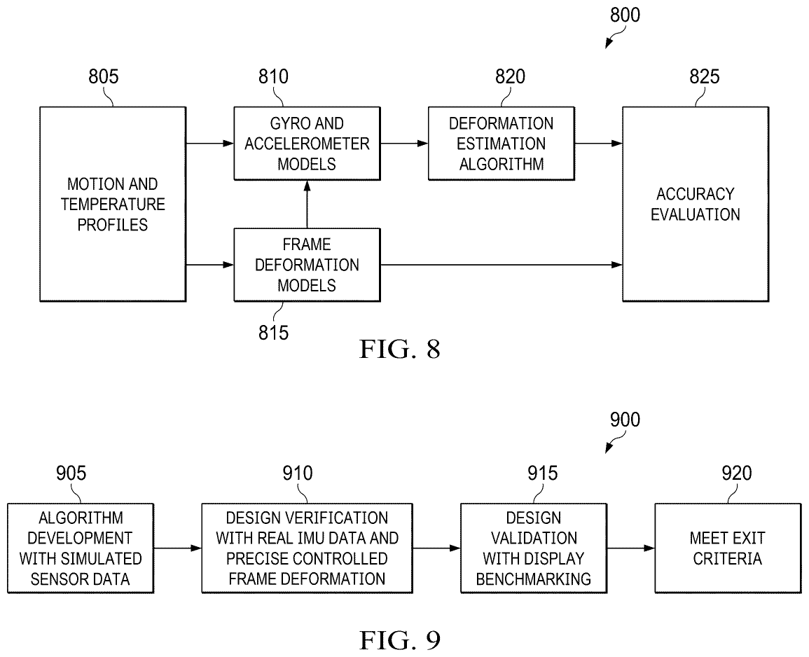

FIG. 8 illustrates a calibration process 800 for modeling, estimating, and evaluating frame deformation in an AR display system (e.g., AR display system 100 of FIG. 1), based on motion and temperature profiles. This process 800 enables accurate calibration and real-time compensation for frame deformation caused by operational stresses, such as temperature changes or mechanical forces.

The process begins with collecting motion and temperature profiles 805, which serve as inputs characterizing the dynamic and environmental conditions experienced by the AR display system during use. In various embodiments, profiles 805 include data such as head movements, temperature fluctuations, and other factors that can induce deformation in the device frame.

In the depicted embodiment, frame deformation models 815 represent how the AR display system's frame (e.g., support frame 110 of FIG. 1) responds to the motion and temperature profiles 805. In certain embodiments, such frame deformation models 815 account for deformation along multiple degrees of freedom (e.g., translations and rotations) and predict how the frame's geometry changes over time. These frame deformation models 815 are used in conjunction with gyro and accelerometer models 810 to inform the calibration process 800. The gyro and accelerometer models 810 simulate the behavior of the IMUs under specified motion and temperature conditions (as specified via motion and temperature profiles 805). These models 810 incorporate factors, for example, such as gyroscope biases, accelerometer misalignments, and temperature sensitivities in the presence of frame deformation characteristics provided via the frame deformation models 815.

The outputs of the gyro and accelerometer models 810, and frame deformation models 815 are fed into a deformation estimation algorithm 820, which integrates sensor data to estimate the actual deformation experienced by the support frame during operation. In certain examples, this algorithm leverages techniques such as extended Kalman filters to dynamically refine the deformation estimates and provide real-time corrections.

In the depicted embodiment, the accuracy of the deformation estimates is assessed via an accuracy evaluation stage 825, which compares the estimated deformation to known values or simulated benchmarks to determine the reliability and precision of the calibration and compensation process.

FIG. 9 illustrates a high-level workflow 900 for developing, verifying, and validating algorithms for frame deformation calibration in an AR display system (e.g., AR display system 100 of FIG. 1). The workflow 900 ensures that the algorithms are robust and meet performance standards for real-world use.

The process 900 begins with algorithm development 905 using simulated sensor data, in which initial models and calibration techniques are created and tested in a virtual environment. Simulated IMU and deformation data are used to refine the algorithm under controlled conditions, enabling early-stage testing without requiring physical prototypes.

Next, the developed algorithm undergoes design verification 910, which utilizes real IMU data and precise controlled frame deformation. In this stage, the algorithm developed in algorithm development stage 905 is validated using data collected from actual IMU sensors subjected to carefully controlled deformation scenarios, testing that the algorithm can accurately estimate deformation when provided with real-world sensor data.

In the depicted embodiment, the workflow 900 proceeds to design validation with display benchmarking 915, in which the algorithm's performance is evaluated in the context of the AR display system's operational requirements. For example, in certain embodiments and scenarios this may include assessing how accurately the algorithm corrects deformation-induced misalignments and its impact on display rendering quality and user experience.

Finally, the workflow 900 concludes with a meet exit criteria stage 920, in which the algorithm is assessed against predefined performance benchmarks, such as calibration accuracy, computational efficiency, and real-time response latency.

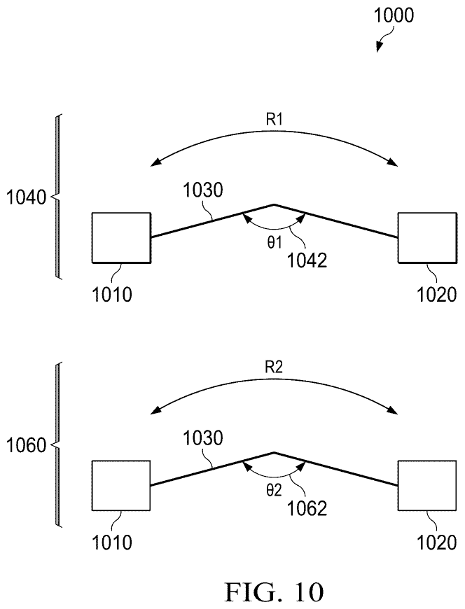

FIG. 10 illustrates an example validation process 1000 for validating deformation calibration algorithms using a deformation rig 1030 and inertial measurement units. The depicted embodiment includes a schematic representation of two IMUs 1010, 1020 positioned on the deformation rig 1030, which undergoes controlled deformations. The process evaluates the accuracy of the calibration by measuring the relative motion and deformation captured by the IMUs 1010, 1020.

The validation process 1000 begins at step 1001 with the deformation rig 1030 set to an initial configuration 1040 in which the angular deformation 1042 (θ1) is measured. The rig 1030 is placed at step 1002 on a three-axis rotation table (e.g., calibration fixture 201 of FIG. 2), and controlled rotations are performed to measure the relative motion between the two IMUs 1010, 1020.

At step 1003, the deformation rig 1030 is adjusted to a new configuration 1060, resulting in an updated angular deformation 1062 (θ2). The same rotational measurements are performed, with the resulting data being compared with the rotational difference obtained from the first IMU measurements. This comparison validates the algorithm's ability to correlate the deformation with the measured rotational data.

The process 1000 is repeated for additional axes and configurations. In the depicted embodiment, the algorithm's performance is validated by comparing the estimated deformations against known values.

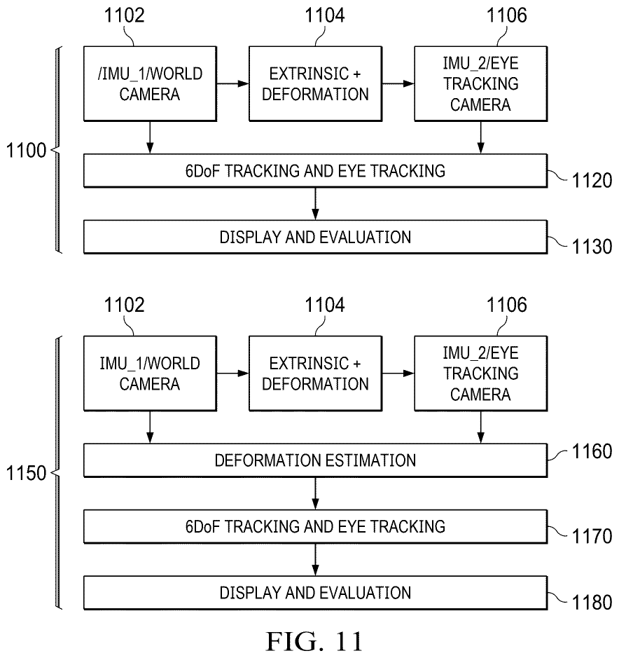

FIG. 11 illustrates a comparison of two workflows 1100, 1150 for achieving 6DoF tracking and eye tracking in an AR display system (e.g., AR display system 100 of FIG. 1). The figure contrasts a direct workflow 1100 without deformation estimation (left) with an enhanced workflow 1150 that incorporates deformation estimation (right). Both workflows 1100, 1150 culminate in display calibration and evaluation, but the inclusion of deformation estimation improves system accuracy and reliability under dynamic operating conditions.

In the workflow 1100, data is collected from two sources: a first IMU 1102 associated with a world camera and a second IMU 1106 associated with an eye tracking camera. The spatial relationship between these components is defined by extrinsic parameters 1104 that include deformation effects caused by mechanical stress, thermal expansion, or aging. The workflow bypasses explicit deformation estimation and directly proceeds to 6DoF tracking and eye tracking stage 1120, using the combined data to align the world camera 1102 and eye-tracking camera 1106. The process 1100 concludes with display and evaluation stage 1130, in which the resulting alignment is tested against visual rendering benchmarks.

The enhanced workflow 1150 introduces an explicit deformation estimation stage 1160 between the extrinsic parameter computation and the 6DoF & eye tracking stage 1170. During deformation estimation stage 1160, deformation effects are dynamically modeled and estimated in real-time based on sensor data from the IMUs and cameras. By integrating the deformation estimation stage 1160, the system accounts for shifts in spatial relationships caused by frame deformation or environmental changes. This additional step improves the accuracy of the 6DoF tracking and eye tracking stage 1170, which is otherwise substantially similar to the corresponding stage 1120 in workflow 1100. The refined alignment is then validated via display and evaluation stage 1180, which is substantially similar to the corresponding stage 1130 in workflow 1100.

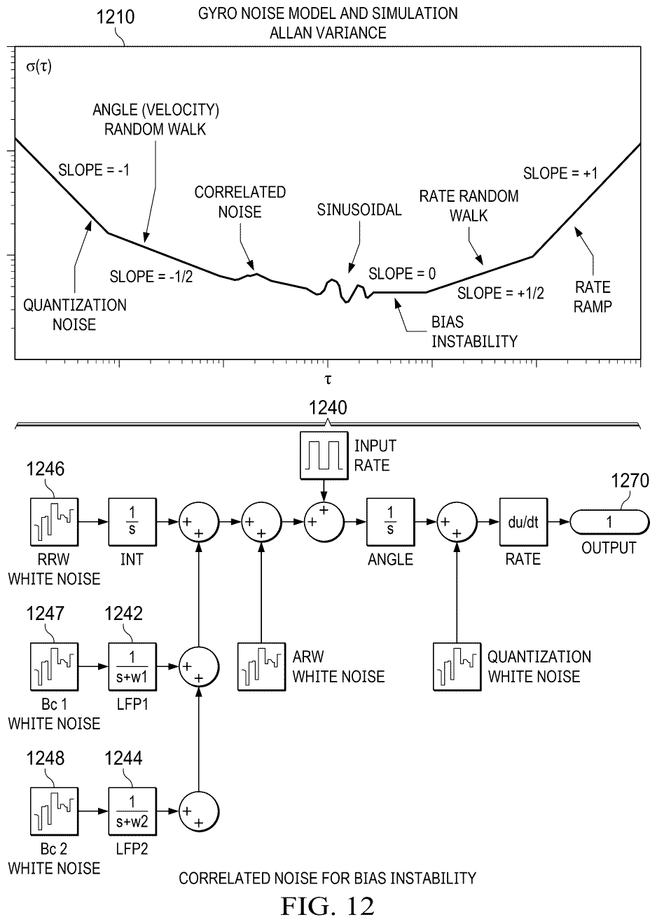

FIG. 12 illustrates a gyro noise model and simulation, depicting an Allan variance plot 1210 and a block diagram of a noise simulation model1240. These are used to characterize and simulate noise behavior in gyroscopes, aiding in the development of calibration and compensation algorithms for AR display systems.

The Allan variance plot 1210 visualizes the relationship between noise characteristics and a time interval, helping to identify various types of gyro noise. The noise simulation model 1240 illustrates how various noise components are simulated to show slow bias drift over time (via rate random walk white noise), high-frequency measurement noise (via angle random walk white noise), sensor quantization effects (via quantization white noise), and correlated noise for bias instability (simulated through low-pass filters 1242 (LPF 1 ) and 1244 (LPF 2 ) fed by white noise sources 1246, 1247, 1248 to mimic slow drift behavior). The simulation model 1240 integrates these noise components into a unified framework, producing an output 1270 that closely resembles the real-world behavior of gyroscope noise.

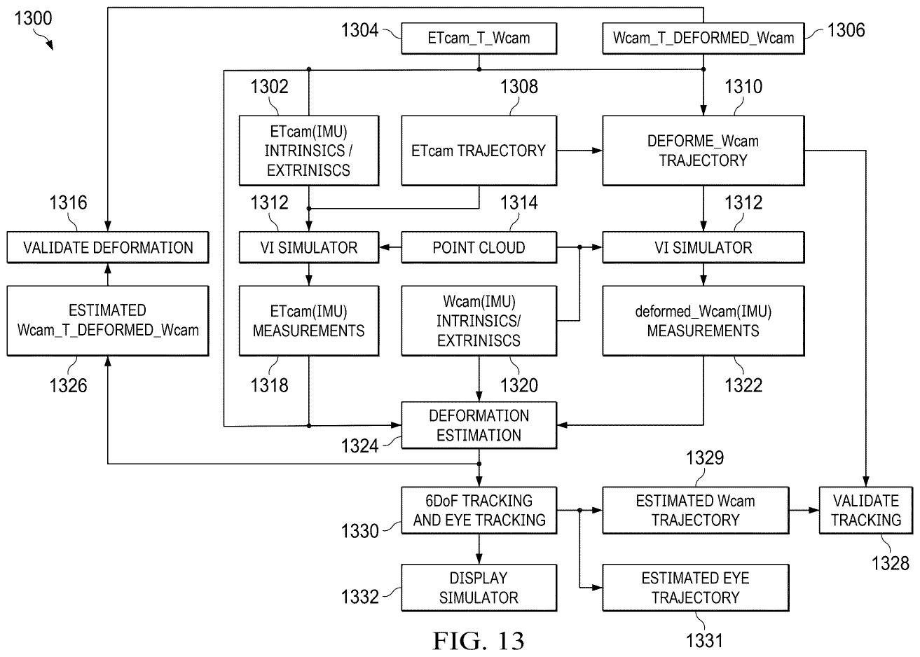

FIG. 13 illustrates a simulation-based workflow 1300 for validating multi-IMU and camera systems in the context of deformation estimation, tracking accuracy, and display performance in AR display systems (e.g., AR display system 100 of FIG. 1). The depicted embodiment integrates multiple processes, including trajectory generation, sensor measurement simulation, deformation modeling, and validation, to ensure that the system accurately captures and corrects frame deformation effects while maintaining robust 6DoF tracking and eye tracking.

The workflow 1300 begins at 1302 with generating intrinsic and extrinsic parameters for the eye-tracking camera (ETcam) and (at 1304) world-facing camera (Wcam), along with their respective trajectories. These trajectories are simulated under both ideal (1308) and deformed (1306, 1310) conditions to assess the effect of frame deformation on spatial alignment. A visual-inertial (VI) simulator 1312 produces synthetic sensor data for IMUs and cameras based on these trajectories (which in the depicted embodiment are stored via a point cloud 1314), enabling the modeling of deformation-induced variations in the Wcam's spatial relationship.

Deformation estimation (1324) is applied to the simulated data (1318, 1322) using eye-tracking intrinsic/extrinsic parameters 1302 and Wcam intrinsic/extrinsic parameters 1320 to calculate the deformed state (1326) of the Wcam relative to its original configuration. The estimated deformation 1326 is validated (1316) by comparing it against the known input deformation, ensuring that the algorithm effectively compensates for dynamic frame distortions. This estimation feeds into 6DoF tracking and eye tracking simulations 1330, in which the accuracy of tracking the Wcam trajectory and the user's eye movements is assessed using an estimated Wcam trajectory 1329 and estimated eye trajectory 1331, respectively.

The final stage involves evaluating (1328) the tracking results within a display simulation 1332, validating how well the corrected trajectories align with the display output. The workflow 1300 iteratively refines and validates both deformation estimation and tracking accuracy by comparing estimated parameters to the corresponding real data.

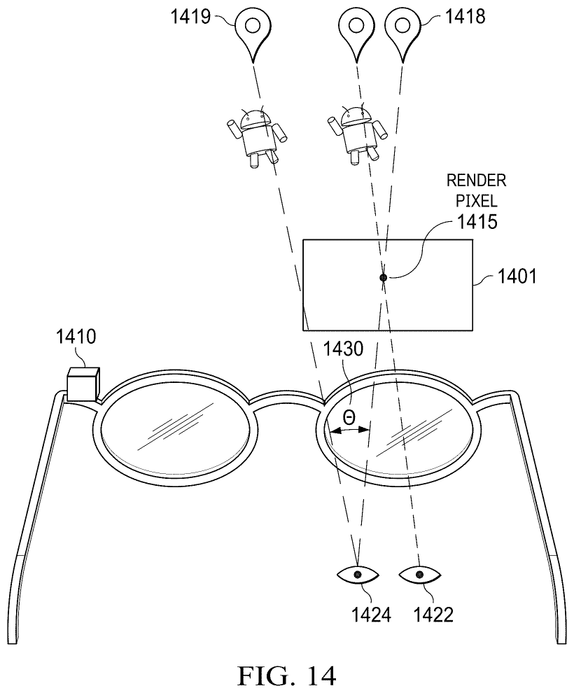

FIG. 14 illustrates one embodiment of techniques for evaluating the alignment accuracy between a rendered pixel on a display and the user's true world point, as perceived through an AR display system (e.g., AR display system 100 of FIG. 1). The embodiment of FIG. 14 visually depicts various alignment relationships, showing an ideal UI, detected UI, and rendered UI in the display plane, along with their corresponding world and pupil positions. This process measures alignment error to enable precise rendering and user comfort in AR applications.

The depicted embodiment includes assessment based on multiple inputs: wcam_T_worldPoint represents a transformation from the world point to the world camera 1410; wcam_T_NominalPupilLoc, a 4×4 transformation matrix indicating the nominal alignment of the pupil with the world camera 1410; and wcam_T_display, a 3×3 calibration transformation for mapping the display's render plane 1401 to the world camera 1410. These inputs establish the spatial relationships necessary for rendering and alignment.

The rendering process calculates the position of a rendered pixel 1415. Specifically, it determines the intersection point between the display plane 1401 and a line extending from the detected world point 1418 to the nominal pupil position 1422. This rendered pixel 1415 represents the system's visual output intended to align with the user's perception of the true world point 1419.

The output of the evaluation is the alignment error 1430, denoted as Θ (theta), which quantifies the angular difference between the true world point 1419 (as it would ideally appear) and the rendered pixel 1415 (as it is actually displayed). This alignment error 1430 is calculated from the true pupil location 1424, using the angular disparity between the ideal UI (true world point) and the rendered UI (detected world point or render pixel).

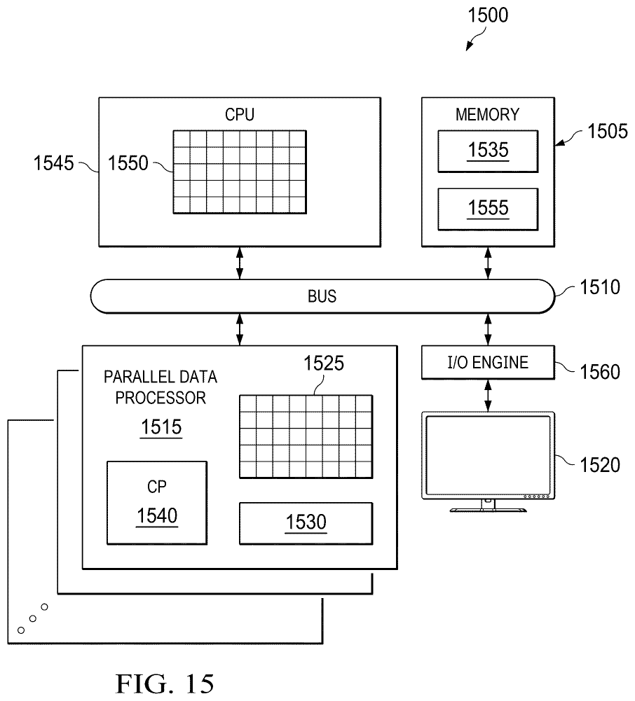

FIG. 15 is a block diagram of a processing system 1500 designed to implement modular calibration of components in AR and other modular devices in accordance with one or more embodiments. The processing system 1500 is generally designed to execute sets of instructions or commands to carry out tasks on behalf of an electronic device, such as a desktop computer, laptop computer, server, smartphone, tablet, game console, and the like.

The processing system 1500 includes or has access to a memory 1505 or other storage component that is implemented using a non-transitory computer readable medium, such as dynamic random access memory (DRAM). The processing system 1500 also includes a bus 1510 to support communication between entities implemented in the processing system 1500, such as the memory 1505. In certain embodiments, the processing system 1500 includes other buses, bridges, switches, routers, and the like, which are not shown in FIG. 15 in the interest of clarity.

The processing system 1500 includes one or more parallel data processors 1515 that are configured to render images for presentation on a display 1520. A parallel data processor is a processor that is able to execute a single instruction on multiple data or threads in a parallel manner. Examples of parallel data processors include graphics processing units (GPUs), massively parallel data processors, single instruction multiple data (SIMD) architecture processors, and single instruction multiple thread (SIMT) architecture processors for performing graphics, machine intelligence, or compute operations. The parallel data processor 1515 can render objects to produce pixel values that are provided to the display 1520. In some implementations, parallel data processors are separate devices that are included as part of a computer. In other implementations such as advance processor units, parallel data processors are included in a single device along with a host processor such as a central processor unit (CPU). Thus, although embodiments described herein may utilize a graphics processing unit (GPU) for illustration purposes, various embodiments and implementations are applicable to other types of parallel data processors.

In certain embodiments, the parallel data processor 1515 is also used for general-purpose computing. For instance, the parallel data processor 1515 can be used to implement machine learning algorithms such as one or more implementations of a neural network as described herein. In some cases, operations of multiple parallel data processors 1515 are coordinated to execute a machine learning algorithm, such as if a single parallel data processor 1515 does not possess enough processing power to run the machine learning algorithm on its own.

The parallel data processor 1515 implements multiple processing elements (also referred to as compute units) 1525 that are configured to execute instructions concurrently or in parallel. The parallel data processor 1515 also includes an internal (or on-chip) memory 1530 that includes a local data store (LDS), as well as caches, registers, or buffers utilized by the compute units 1525. The parallel data processor 1515 can execute instructions stored in the memory 1505 and store information in the memory 1505 such as the results of the executed instructions. The parallel data processor 1515 also includes a command processor 1540 that receives task requests and dispatches tasks to one or more of the compute units 1525.

The processing system 1500 also includes a central processing unit (CPU) 1545 that is connected to the bus 1510 and communicates with the parallel data processor 1515 and the memory 1505 via the bus 1510. The CPU 1545 implements multiple processing elements (also referred to as processor cores) 1550 that are configured to execute instructions concurrently or in parallel. The CPU 1545 can execute instructions such as program code 1555 stored in the memory 1505 and the CPU 1545 can store information in the memory 1505 such as the results of the executed instructions.

An input/output (I/O) engine 1560 handles input or output operations associated with the display 1520, as well as other elements of the processing system 1500 such as keyboards, mice, printers, external disks, and the like. The I/O engine 1560 is coupled to the bus 1510 so that the I/O engine 1560 communicates with the memory 1505, the parallel data processor 1515, or the CPU 1545.

In operation, the CPU 1545 issues commands to the parallel data processor 1515 to initiate processing of a kernel that represents the program instructions that are executed by the parallel data processor 1515. Multiple instances of the kernel, referred to herein as threads or work items, are executed concurrently or in parallel using subsets of the compute units 1525. In some embodiments, the threads execute according to single-instruction-multiple-data (SIMD) protocols so that each thread executes the same instruction on different data. The threads are collected into workgroups (also termed thread groups) that are executed on different compute units 1525. For example, the command processor 1540 can receive these commands and schedule tasks for execution on the compute units 1525.

In some embodiments, the parallel data processor 1515 implements a graphics pipeline that includes multiple stages configured for concurrent processing of different primitives in response to a draw call. Stages of the graphics pipeline in the parallel data processor 1515 can concurrently process different primitives generated by an application, such as a video game. When geometry is submitted to the graphics pipeline, hardware state settings are chosen to define a state of the graphics pipeline. Examples of state include rasterizer state, a blend state, a depth stencil state, a primitive topology type of the submitted geometry, and the shaders (e.g., vertex shader, domain shader, geometry shader, hull shader, pixel shader, and the like) that are used to render the scene.

As used herein, a layer in a neural network is a hardware- or software-implemented construct in a processing system, such as processing system 1500. In various embodiments, such a layer may perform one or more operations via processing circuitry of the processing system 1500 to serve as a collection or group of interconnected neurons or nodes, arranged in a structure that can be optimized for execution on one or more parallel data processors (e.g., parallel data processors 1515) or other similar computation units. Such computation units can, in certain embodiments, comprise one or more graphics processing units (GPUs), massively parallel data processors, single instruction multiple data (SIMD) architecture processors, and single instruction multiple thread (SIMT) architecture processors.

Each layer processes and transforms input data—for example, raw data input into an input layer or the transformed data passed between hidden layers. This transformation process involves the use of an output weight matrix, which is held in memory (e.g., memory 1505) and manipulated by the central processing unit (CPU) 1545 and/or the parallel data processors 1515.

In some instances, such layers may be distributed across multiple processing units within a system. For instance, different layers or groups of layers may be executed on different compute units 1525 within a single parallel data processor 1515, or even across multiple parallel data processors if warranted by system architecture and the complexity of the neural network.

The output of each layer, after processing and transformation, serves as input for the subsequent layer. In the case of the final output layer, it produces the results or predictions of the neural network. In various embodiments, such results can be utilized by the system or fed back into the network as part of a training or fine-tuning process. In some embodiments, the training or fine-tuning process involves adjusting one or more weights in the output weight matrix associated with each layer to improve performance of the neural network.

In some embodiments, certain aspects of the techniques described above may be implemented by one or more processors of a processing system executing software. The software comprises one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

A computer readable storage medium may include any storage medium, or combination of storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disk, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A method comprising:
prior to assembly of a display system, collecting sensor data from multiple modular components of the display system;
estimating one or more deformation parameters of a support frame of the display system based at least in part on the collected sensor data and one or more deformation models;
calibrating intrinsic parameters of each modular component based on the collected sensor data;
calibrating one or more extrinsic parameters defining spatial relationships between the modular components based on the estimated deformation parameters; and
providing as output the calibrated intrinsic parameters and extrinsic parameters for each modular component for use in assembly of the display system.

2. The method of claim 1, wherein the display system comprises one or more of a group that includes a virtual reality display system, an augmented reality display system, an artificial intelligence display system, or a wearable near-eye display system.

3. The method of claim 1, wherein at least one of the multiple modular components of the display system comprises one of a group that includes a camera module of the display system, a display module of the display system, or an audio module of the display system.

4. The method of claim 1, further comprising generating one or more modification profiles associated with the display system, wherein at least one of the one or more modification profiles comprises one of a group that includes a motion profile of the display system or a temperature profile of the display system.

5. The method of claim 3, further comprising simulating, based at least in part on the one or more modification profiles, inertial measurement unit sensor behavior using one or more of a group that includes a gyro model and an accelerometer model.

6. The method of claim 1, wherein the intrinsic parameters for at least one of the multiple modular components comprises one or more of a group that includes optical parameters, spatial alignment, or sound mapping characteristics.

7. The method of claim 1, wherein the extrinsic parameters for at least one of the multiple modular components comprises one or more of a group that includes a translation vector between the at least one modular component and one or more additional modular components of the multiple modular components or a rotation matrix between the at least one modular component and one or more additional modular components of the multiple modular components.

8. An eyewear display device assembled according to the method of claim 1.

9. A method comprising:
prior to assembly of a display system, collecting sensor data from multiple modular components of the display system;
calibrating intrinsic parameters of each modular component based on the collected sensor data;
calibrating one or more extrinsic parameters defining spatial relationships between the modular components; and
assembling the display system based at least in part on the calibrated one or more intrinsic parameters and the calibrated one or more extrinsic parameters.
